(19) United States
(12) Patent Application Publication
(10) Pub. No.: US 2018/0244030 A1
(43) Pub. Date: Aug. 30, 2018

(54) METHOD AND APPARATUS FOR CONTINUOUSLY MAKING COMPOSITE STRIP OR SHEETS

(71) Applicants: BWG BERGWERK-UND WALZWERK-MASCHINENBAU GMBH, Duisburg (DE); THYSSENKRUPP STEEL EUROPE AG, Duisburg (DE)

(72) Inventors: Andreas NOE, Kerken (DE); Josef SCHNEIDER, Wenden (DE); Mattias STASKE, Kevelaer (DE); Klemens HEERMANN, Dorsten (DE); Andreas KLARE, Luenen (DE); Klaus-Peter KOCH, Schwelm (DE); Gerold RASPUDIC, Kreuztal (DE); Markus RUDACK, Aachen (DE); Stella JANSSEN, Duesseldorf (DE)

(21) Appl. No.: 15/755,062

(22) PCT Filed: Sep. 21, 2016
(86) PCT No.: PCT/EP2016/072450

§ 371 Date: Feb. 24, 2018

(30) Foreign Application Priority Data
Oct. 8, 2015 (DE) 10 2015 117 201.1

(51) Int. Cl. B32B 37/20; B32B 15/08; B32B 38/16; B32B 38/00; B32B 39/00

(52) U.S. Cl. CPC B32B 37/203; B32B 15/08; B32B 39/00; B32B 38/164; B32B 38/162

(57) ABSTRACT

The invention relates to a method for producing composite webs or composite sheets, consisting of at least a first lower cover layer (1) of metal, a second upper cover layer (2) of metal, and a core layer (3) of plastic, which is arranged between the cover layers (1, 2) and is integrally bonded thereto, wherein a first metal strip (4) for the lower cover layer (1), a second metal strip (5) for the upper cover layer (2), and a plastic web (6) for the core layer (3) are brought together and are integrally bonded to each other by the application of pressure and/or heat. The method is characterized in that the first metal strip (4) and the second metal strip (5) are each continuously coated with an adhesion promoter in a pretreatment line (V) and then wound and that the first metal strip (4), the second metal strip (5), and the plastic web (6) are then brought together in a laminating line that is separate from the pretreatment line (L) and are continuously bonded to each other by the application of pressure and heat in order to form a composite web.

The invention relates to a method of making composite strip or sheets consisting of at least one first (for example lower) outer layer of metal, one second (for example upper) outer layer of metal, and at least one core layer of plastic that is sandwiched between the outer layers and integrally joined therewith, with a first metal strip for the first outer layer, a second metal strip for the second outer layer, and at least one plastic web (for example plastic film) for the core layer being brought together and integrally joined with one another under the application of pressure and/or heat.

Such metal/plastic composite sheets or sandwich sheets are used in automotive engineering, for example. It is intended to replace conventional steel sheets and aluminum sheets, since it is lighter than steel sheets on the one hand and more cost-effective than aluminum sheets on the other. The outer sheets have a thickness in the range from 0.1 mm to 1 mm, for example, and the core layer of plastic has a thickness of 0.05 mm to 3 mm, for example. Such composite sheets are used in a wide range of applications in automotive engineering, such as for auto body panels for the outer skin and for structural and reinforcing parts. The sandwich sheets are characterized by a high level of flexural and buckling strength, and they also have good shaping properties, so that they have outstanding workability for processing into parts. Besides the reduction in weight and cost, such sandwich sheets also make it possible to improve the acoustic heat insulation characteristics.

During manufacturing, cold-rolled steel sheets are first provided for the outer sheets, for example, with these steel sheets generally being annealed, conditioned, and (electrolytically) galvanized. The outer sheets manufactured in this way are then brought together as the first, upper outer layer and second, lower outer layer through interposition of the plastic web and joined together under pressure and/or heat as the plastic core layer is integrally joined with both the upper outer layer and with the lower outer layer.

A method of manufacturing composite strip or sheets is known for example from DE 10 2013 110 282. There, the two outer sheets are to be formed by a metal sheet whose surface has different roughnesses. The plastic layer is to be made of polyamide, polyethylene, or a mixture of polyamide and polyethylene. Before the one-sided application of the plastic layer, the conditioned metal strip is first pretreated at one or more processing stations. For instance, the strip undergoes alkaline degreasing and/or cleaning at one processing station. In a subsequent processing station, the strip surface is passivated in one or more chemical pretreatment baths and thus prepared for the coating. Moreover, a processing station can be provided for applying an adhesion promoter or adhesive on one side. After this pretreatment, a plastic layer is applied to the side of the strip on which adhesion promoter or adhesive has been optionally provided. It can be laminated in the form of a prefabricated plastic film onto the strip, for example, such as with a laminater having press rolls, for example, with it being possible for at least one of the rolls of the laminater to be heated. After the application of the plastic layer, the strip that has been coated on one side passes through a cooler and/or dryer. After that, the strip is wound into a coil and stored for the interim, or it is forwarded directly to a device for applying a outer sheet or a outer sheet that has also been coated on one side with a plastic layer. In this downstream device, two ribbon-shaped semifinished products are then brought together, each of which consists of a outer sheet and a plastic coating, with the two semifinished products being unwound from respective unwinding reels and fed to a pair of rollers in such a way that the two plastic layers of the semifinished products face toward and lie against one another. Immediately before the semifinished products are introduced into the roll gap defined by the rolls, the plastic layers of both semifinished products are activated by agents acting from the plastic surface side (see DE 10 2013 110 282).

A similar method of manufacturing composite sheets is described in DE 10 2013 013 495 [US 2014/0178633]. There, the activation of the plastic layer of the semifinished products occurs directly from the side of the semifinished product that is coated with plastic.

In DE 10 2011 015 071 [US 2016/0193776] and DE 10 2012 106 206 [US 2015/0202844], sandwich sheets are described in which the plastic layer is made of fiber-reinforced plastic.

Alternatively, EP 2 193 021 [US 2010/0233505] describes a sandwich sheet in which the core layer is made of a plastic foam layer having a polyamide-polyethylene blend.

Furthermore, a method of manufacturing composite sheets is also described in EP 2 896 502 [US 2016/0318294]. An adhesion promoter layer can be applied to the metal strips by plasma-coating.

DE 10 2013 201 388 [US 2015/0375478] relates to the manufacture of metal-plastic hybrid components comprising metal and plastic, with the metal surface being pretreated by application of at least one conversion layer. Afterward, at least one layer of an adhesion promoter composition is applied, and the metal is then joined with the plastic. The adhesion promoter composition contains at least one copolyamide-based hot-melt adhesive.

Finally, DE 10 2009 013 712 discloses the manufacture of composite elements, for example sandwich plates having a first outer layer and a second outer layer, with a foam layer being between the outer layers. The boundary surfaces between the foam layer and at least one outer layer has an adhesion promoter layer. At least the application of the adhesion promoter layer and the application of the foam layer can be carried out in a discontinuous operation mode.

All things considered, a need exists for high-quality composite sheets of the above-described type that can be manufactured economically.

It is the object of the invention to provide a method with which high-quality composite strip or sheets can be manufactured economically. To achieve this, an apparatus is to be provided as well that enables high-quality composite strips to be manufactured economically and, in particular, operates without any problems and minimizes the strip scrap length.

In order to achieve this object in a method of the above-described type, the invention teaches that
the first metal strip and the second metal strip are each continuously coated (on one side) with an adhesion promoter on a (continuous) pretreatment line and subsequently wound up, and
the first metal strip and the second metal strip and the plastic web are subsequently brought together in a (continuous) lamination line that is separate from the pretreatment line and joined together continuously under application of pressure and/or heat to form a composite sheet.

The invention proceeds in this regard from the insight that high-quality composite webs or sheets can be manufactured economically in two separate treatment lines. In a first manufacturing process, the entire pretreatment of the metal strips provided is performed and, particularly, an adhesion promoter is applied that enables flawless interconnection of the metal strips with the sandwiched plastic web in a later method step. Moreover, additional pretreatment steps that will be discussed below can be carried out on this pretreatment line. However, the application of the plastic web is expressly omitted in the course of this pretreatment. As a result of the pretreatment in the pretreatment line, flawlessly prepared metal strips that are coated with adhesion promoter are thus provided that are wound into coils. These pretreated, wound metal strips can then be transported to the second line, namely the lamination line, optionally after interim storage. On this lamination line, the prepared metal strips are then joined together in a continuous operation with interposition of the plastic web under application of pressure and heat and thus processed into a composite sheet. The plastic web is thus fed in for the first time in the lamination line on which the composite strip and/or the composite sheet is produced from the two metal strips.

The configuration according to the invention enables strip scrap to be minimized particularly in the event of product changeovers or also malfunctions. After all, the strips prepared on the separate pretreatment line are provided for the manufacture of the composite webs in the lamination line. For example, if the lamination process has to be stopped due to a malfunction or production fault, then this has no impact in the pretreated strip that is already in the lamination line that therefore need not be discarded as scrap but rather can in fact be further processed after startup, particularly since the strip coaters that would result in scrap production in the event of varying strip speeds or strip stoppage are not in the lamination line but rather integrated into the separate pretreatment line.

Apart from that, it is advantageous that a complete inspection of the pretreated strip is possible after the pretreatment before the strip is then indeed further processed into a composite sheet. In particular, this makes it possible to check whether the outside of the metal strip has defects. Defective strips can thus be rejected before they are processed into composite sheets. In addition, since only one of the two outer sheets forms the outside or outer skin in the subsequent product (an auto body panel, for example), it is possible to use pretreated strips with minor defects for the “interior” outer sheet, thereby enabling the cost-effectiveness to be further improved.

The separation into two lines is especially advantageous in that both the metal strips for the upper outer layer and the metal strips for the lower outer layer can be pretreated (successively) in one and the same pretreatment line. This is advantageous particularly because the pretreatment line can be especially preferably operated at a higher speed than the lamination line. After all, the pretreatment, particularly the application of the adhesion promoter, can be performed at a substantially higher speed than the (subsequent) lamination and thus the joining of the metal strips with the plastic web. It is also important in this context that coating of the metal strips with the adhesion promoter can be carried out using a strip-coater, for example, that is a roller or roll coater and has at least one application roller and, optionally, a support roller. Such roller strip-coaters are known from practice and also described for example in EP 1 808 237 [U.S. Pat. No. 7,647,882]. The high-quality coating of the strips with roller coaters can be performed economically especially if the continuous coating is carried out at relatively high minimum speeds. According to the invention, it is now advantageous that the coating of the strips with the adhesion promoter can be carried out at a different (particularly higher) speed than the actual lamination, since these processes are done on two different lines. However, the invention also includes embodiments in which other coaters are used, such as coaters that work by injection or dipping. Nevertheless, roller coaters generally have the advantage that they work flawlessly even at varying stock speeds, have low tolerances, and also happen to be very environmentally friendly.

In an especially preferred development, the pretreatment line is operated at at least twice the speed as the lamination line. This offers the advantage that both the metal strips for the first (for example upper) outer sheets and the metal strips for the second (for example lower) outer sheets can be (successively) pretreated in the pretreatment line and, by virtue of the doubled processing speed, metal strips will still be available both for the upper outer sheets and for the lower outer sheets for the adjacent lamination line. In a preferred development, even higher speeds can be used in the pretreatment line. This makes it possible to optionally supply several lamination lines with one pretreatment line. This is attractive especially because the described pretreatment line can be operated at substantially higher speeds than the lamination line. All in all, it is advantageous that the lamination line on the one hand and the pretreatment line on the other hand can be operated at very different process speeds.

The fact that both the upper outer sheets and the lower outer sheets can be precoated in one and the same pretreatment line also offers the substantial advantage that the overall apparatus can be implemented very economically, since it is not necessary to make all of the pretreatment apparatus available both for the upper outer sheets and for the lower outer sheets. Unlike an apparatus in which the pretreatment and particularly the precoating with adhesion promoter is integrated into the lamination line and in which commensurate pretreatment equipment has to be provided both for the upper outer sheet and for the lower outer sheet, the equipment costs can be reduced substantially. Moreover, it is advantageous that flat and inspected strips are available for use on the separate lamination line, so that problems in the downstream, separate lamination line can be reduced.

It lies within the scope of the invention for additional pretreatment steps to be integrated into this continuous pretreatment process in the pretreatment line, particularly in order to optimize the strips for the application of the adhesion promoter. For instance, pre-cleaning (in a precleaner, for example) and post-cleaning (in a post-cleaner) is particularly carried out before the precoating. Moreover, the strips can be aligned, i.e. stretch-bend straightened and/or lengthened, during pretreatment in order to provide flat strips for precoating and/or lamination.

The precoating with an adhesion promoter is of particular importance. This precoating can be performed by phosphatizing or in another manner. This ensures that a flawless bond is achieved with the subsequent lamination process between the metal strips on the one hand and the plastic web on the other hand in order to form a full-surface integral connection. For instance, a layer can be formed during phosphatization from securely adhering metal phosphates with the aid of an aqueous phosphate solution. Alternatively, however, other adhesion promoter layers can also be considered.

The metallic outer sheets preferably have a thickness of from 0.1 mm to 1 mm, preferably 0.2 mm to 0.6 mm.

The intermediate layer of plastic has a thickness of from 0.05 mm to 3 mm, for example 0.3 mm to 2 mm. Here, the thickness of the intermediate layer refers to the thickness of the intermediate layer in the finished product and thus within the composite sheet.

The plastic web is preferably a plastic film. The plastic web can be made of a thermoplastic plastic such as polyethylene, polypropylene, and/or polyamide, for example. In the context of the invention, “plastic” or “plastic web” also refers to plastic webs or plastics into which additional particles or the like are integrated, for example fibers, and thus particularly to fiber-reinforced plastics or plastic webs. Webs are thus also included that have plastic as a component or are basically made of plastic. Furthermore, a plurality of plastic webs, for example two plastic webs, can also be provided between the outer layers.

Thermoplastic plastics with relatively high melting points are preferably used in order to then also enable the composite strip or sheets to be processed at higher temperatures, such as during painting, for example, over the course of application and further processing.

For instance, plastic webs made of a polyethylene-polyamide compound core having a melting temperature of greater than 200° C., for example 200° C. to 250° C., for example approximately 220° C. can be used for the core layer.

In the lamination line that is separate from the pretreatment line, the metal strips are brought together with interposition of the plastic web and joined together continuously under the application of pressure and heat to form a composite sheet. Both the pretreatment line on the one hand and the lamination line on the other hand are thus preferably continuous lines that work separately from one another and in which the treatment of the metal strips is continuous.

The object of the invention is also an apparatus for manufacturing composite strip or sheets of the described type. Such an apparatus has a pretreatment line for coating the first metal strip and the second metal strip on the one hand and a lamination line that is separate from the pretreatment line for joining the metal strips with interposition of the plastic web on the other hand.

The pretreatment line has at least one unwinder (for unwinding the metal strip to be treated), a coater (for coating the metal strip with an adhesion promoter), and a winder (for winding up the coated metal strip). The coater is preferably a roller coater with at least one application roller and, optionally, a support roller. Moreover, the pretreatment line can have at least one cleaner, for example a precleaner and a post-cleaner upstream from the coater. Optionally, the pretreatment line can have a straightener, for example a stretch-bend straightener, that is preferably also upstream of the coater. For instance, it lies within the scope of the invention for a first straightener, then a precleaner, then a second straightener, and then a post-cleaner to be provided upstream of the unwinder. The post-cleaner can then be followed by the coater in the form for example of a roll coater, optionally with interposition of a dryer. The coater can be followed by a heater, such as for example a furnace through which the precoated strip travels. The heater can be optionally followed by a cooler. The pretreatment line then ends with the above-described winder. Moreover, the pretreatment line can have additional common apparatus components, particularly sets of tension rollers, drives, strip accumulators, etc.

The lamination line has at least one first unwinder (for unwinding the coated first metal strip), one second unwinder (for unwinding the coated second metal strip), and one third unwinder for the plastic web. Moreover, a joiner is provided in which the metal strips can be brought together with interposition of the plastic web. Furthermore, a heater and/or press is provided downstream from the joiner in which the integral bond between the metal strips and the sandwiched plastic web is established and/or completed. As a matter of principle, it lies within the scope of the invention to feed the plastic web in directly over the course of the joining of the metal strips so that the plastic web is introduced as desired into the merging gap between the two metal strips. In a preferred development of the invention, however, the joining of the metal strips and the plastic web is performed in at least two steps. For this purpose, the joiner preferably has a first laminater with which the plastic web is joined together with the first metal strip (for example the lower metal strip) and a second laminater with which the second metal strip (for example the upper metal strip) is brought together with the plastic web that is on or against the first metal strip. It thus lies within the scope of the invention to feed in the first metal strip (for example the lower metal strip) and to join the plastic web together with the first metal strip, thereby laminating the plastic web onto the first metal strip, for example. The second metal strip is then fed in, so that a second laminating or covering process is then carried out in the second laminater.

The bond created in this way is then completed in the heater and/or press. To achieve this, the heater and press can have a heater (for example a continuous furnace) on the one hand and a separate press that is downstream from the heater on the other hand that is for example a roller arrangement or calender. An additional heater and/or a cooler can then optionally follow this press.

In a preferred development, appropriate temperature control of the metal strips and plastic web is done in the joiner and thus during covering or lamination. The joiner therefore preferably has a preheater for the first metal strip, a preheater for the second metal strip, a preheater for the plastic web, and/or a post-heater for the first metal strip and the plastic web thereon. A wide range of possibilities thus exist in the context of the invention to adapt the temperature-controlling of the strips and/or webs to the desired situation and particularly also to the temperature characteristics of the thermoplastic plastic being used and thus optimizing the process.

Optionally, it can be advantageous to join the metal strips together locally in the lamination line at process startup at the leading end of a strip using an (additional) strip joiner. Such a joining of the two metal strips is performed in the startup process, especially preferably without sandwiched plastic web. The joining can be achieved through punching, riveting, clinching, and/or welding or also for example gluing. Such strip joiners are known from process lines for the manufacture of metal strips. In the described apparatus, they are optionally at the joiner or in the workpiece-travel direction downstream of the joiner and upstream of the heater and/or press. By virtue of this additional local strip connection at the leading end of the strip and/or at the leading end of one of the metal strips, delamination of this region while passing through the lamination line is prevented. The startup process can be optimized overall, and it is also ensured that, when passing through the lamination line and particularly the corresponding heating and, optionally, pressing sections, the two surfaces of the arrangement of metal strips passing through is formed by metal strips from the leading end and not by the plastic strip.

Optionally, the possibility also exists of integrating a skin-pass mill for the temper-rolling of the metal strips, with such a skin-pass mill being preferably arranged upstream of a stretch-bend straightener, for example immediately upstream of a stretch-bend straightener.

In addition, the possibility also exists of providing the outer sheets with a film, for example a protective film, on one side, specifically on the outer surface of the respective outer sheet opposite the adhesion promoter. Such a film can be applied to the outer sheet through cold lamination, particularly in the pretreatment line and/or in the lamination line.

The invention is explained in further detail below with reference to a schematic drawing that illustrates only one embodiment.

FIG. 1 is a simplified cross section through a composite strip or sheet,

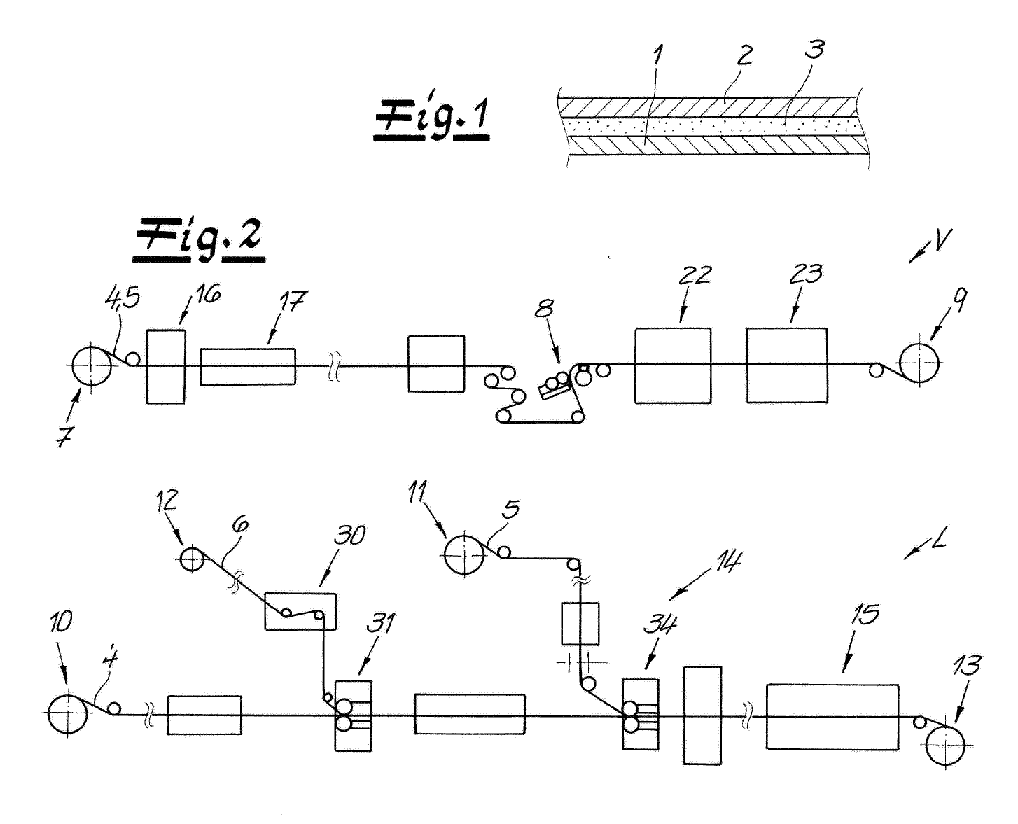

FIG. 2 is a highly simplified, schematic view of an apparatus for manufacturing a composite strip with a pretreatment line on the one hand and a separate lamination line on the other hand,

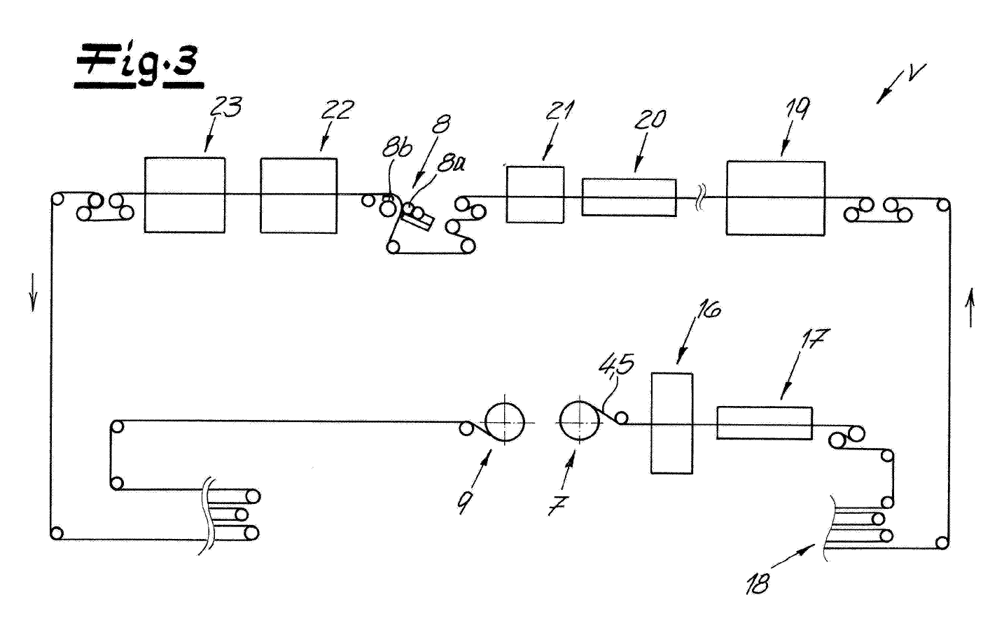

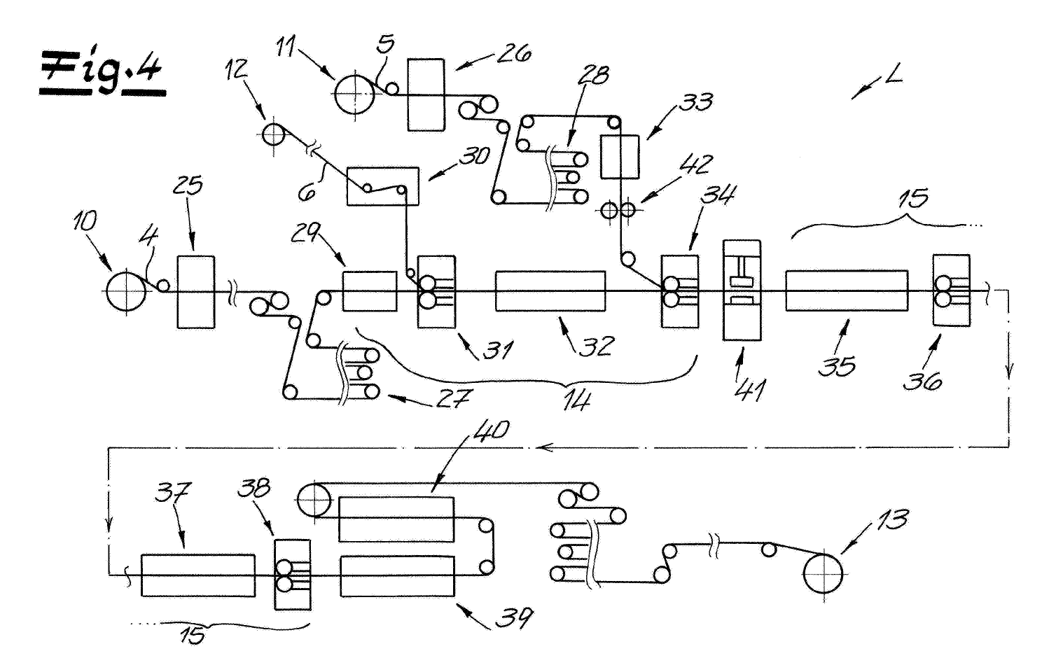

FIG. 3 is a simplified view of the pretreatment line of the apparatus according to FIG. 1, and

FIG. 4 is a simplified schematic view of the lamination line of the apparatus according to FIG. 1.

With the apparatus shown in FIGS. 2 to 4, composite strip or sheets can be produced that are made of at least one lower outer layer 1 of metal, one upper outer layer 2 of metal, and one core layer 3 of plastic that is between the outer layers 1, 2, with the outer layers 1, 2 being integrally joined with the plastic core layer 3 (see FIG. 1).

As shown in FIG. 2, in order to produce composite strips as in FIG. 1, a first metal strip 4 for the lower outer layer and a second metal strip 5 for the upper outer layer and a plastic web 6 for the core layer are supplied to the apparatus. The first metal strip 4 and the second metal strip 5 and the plastic web 6 are continuously brought together and joined integrally with one another under the application of pressure and/or heat. The metal strips 4 and 5 are thus provided as a starting product for the process according to the invention for manufacturing composite strips. They are metal strips made of steel, for example, such as electrolytically galvanized and optionally oiled steel strips. Alternatively, however, strips of aluminum or other metals can also be used.

According to the invention, composite strips are manufactured from such steel strips 4 and 5 in an apparatus that is composed of two separate, continuously operating lines, namely a pretreatment line V on the one hand and a lamination line L on the other hand (see FIG. 2).

Both the first metal strip 4 and the second metal strip 5 are each coated on one side with an adhesion promoter on a (single) continuously operating pretreatment line V and then wound up.

The (pretreated and precoated) first metal strip 4 and the (pretreated and precoated) second metal strip 5 and the plastic web 6 are subsequently brought together in a continuously operating lamination line L separate from the pretreatment line V and joined together continuously under application of pressure and heat to form a composite strip. The pretreatment line V is shown in detail in FIG. 3, and the lamination line L, which is separate therefrom, is shown in detail in FIG. 4.

The pretreatment line V has at least one unwinder 7 for the first metal strip 4 and the second metal strip 5, at least one coater 8 for coating the metal strips 4 and 5 with an adhesion promoter, and a winding device 9.

In this way, pretreated and/or precoated metal strips 4 and 5 that are wound onto coils are available for the subsequent lamination process.

The lamination line L in turn has a first unwinder 10 for the first metal strip 4, a second unwinder 11 for the second metal strip 5, and an unwinder 12 for the plastic web 6. Moreover, a winder 13 for the finished composite web can be provided, for example. Furthermore, the lamination line L has a joiner 14 in which the metal strips 4 and 5 are brought together with interposition of the plastic web 6. The joiner 14 is then followed by a heater and/or press 15 in which the bond between the outer sheets 4 and 5 and the sandwiched plastic web 6 is created and/or completed.

Of particular importance according to the invention is the fact that, as shown in FIG. 2, the pretreatment on the one hand and the lamination and/or covering on the other hand are carried out on separate lines, with these separate lines then each operating continuously. Provision is made that only a single pretreatment line V that pretreats both the lower outer sheets 4 and the upper outer sheets 5 is associated with the lamination line L. It is advantageous in this regard if the pretreatment line V operates at a substantially higher speed than the lamination line L, preferably at (approximately) twice the speed, so that the pretreatment line, at twice the speed, is adapted to the capacity of the lamination line, enabling both first metal strips 4 and second metal strips 5 to be provided in sufficient quantity by the pretreatment line V.

The construction and functionality of the pretreatment line V can be clarified on the basis of FIG. 3:

The metal strips 4 and 5 are unwound by the unwinder 7 and initially aligned in a first straightener 16. The purpose of this first straightener 16 (immediately) downstream of the unwinder 7 is to correct curvature, particularly to eliminate curvatures that are created by winding up of the strips. Various processing machines can follow that are not shown in detail (scissors, scrap disposal, drives, staplers, side punches, etc.). The metal strips 4 and 5 then pass through a first cleaner and/or precleaner 17 and, optionally, a strip accumulator 18. The first cleaner 17 is followed by a second cleaner 19 that can be a stretch-bend straightener for improving the flatness of the strip. This second straightener 19 is followed by a second cleaner 20 and/or post-cleaner. The strip then passes through a dryer 21, for example that can be a hot-air dryer, for example. The above-described coating with an adhesion promoter is then performed with the strip coater 8 that is a roll coater or roller coater here and has at least one application roller 8a and one support roller 8b. The strip coater 8 is followed by a heater 22 (for example a furnace) and optionally a cooler 23 (for example an air cooler).

The metal strip 4 and 5 pretreated in this way is then wound up by the winder 9. The pretreated metal strip 4 and 5 is thus provided as a cleaned, straightened strip that has been precoated with adhesion promoter on coils that are then available for the manufacture of the composite strips in the lamination line L.

The construction and functionality of the lamination line V can be clarified with reference to FIG. 4:

The lamination line L has a first unwinder 10 for the first metal strip 4 and a second unwinder 11 for the second metal strip 5. The unwinders 10 and 11 can each be optionally followed by respective straightening machines 25 and 26 and, optionally, respective strip accumulators 27 and 28. The first metal strip 4 for the lower outer sheet is preheated in a preheater 29, for example a furnace. This preheated lower metal strip 4 is subsequently brought together with the plastic web 6. To achieve this, the plastic web 6 is unwound by the unwinder 12 and also preheated in a preheater 30 and then brought together with the first metal strip 4, particularly in a first laminater 31 that can be a roller arrangement or calender. This first laminater 31 is followed by a post-heater 32, for example a furnace, with which the temperature of the first metal strip and the plastic web 6 thereon are further controlled.

The second metal strip 5 is also preheated in a preheater 33 and then brought together in a second laminater 34 with the first metal strip 4 and the plastic web 6 thereon. This second laminater 34 can again be a roller arrangement or calender. The second laminater 34 is followed by the heater and press 15 that has at least one heater 35, for example a furnace, and a press 36 and optionally an additional heater 37 and an additional press 38. Moreover, coolers 39, 40 are then preferably provided with which the finished composite strip is cooled before it is subsequently wound by the winding device 13 or optionally subdivided right away into sheets in a suitable apparatus.

Moreover, FIG. 4 shows that the lamination line is equipped with a strip joiner 41 that joins the two metal strips 4 and 5 together locally during startup of the lamination line L (in addition to) and independently of the integral connection via the plastic web. For this purpose, the strip joiner 41 makes a punched or stapled connection, for example, or is a clincher or as a welder or the like. Preferably, the two metal strips 4 and 5 are joined together locally with one another during the startup process without the plastic web 6. This local strip connection at the leading end of a strip prevents delamination at the leading end of the strip as it continues to pass through the following apparatus components, particularly the heaters and presses.

During startup of the lamination line L, the first (lower) metal strip 4 is preferably drawn completely into the lamination line and pulled through the lamination line L by the winding device 13. The plastic web 6 is laminated onto the lower metal strip 4 in the first laminater 31. Before the first metal strip with the plastic web 6 thereon then reaches the second laminater 34, the lower metal strip 4 is stopped. Now the upper metal strip 5 is fed via a drive 42 so that the upper metal strip 42 is placed onto the lower metal strip 4 without a plastic web. The upper metal strip 5 is guided into the vicinity of the strip joiner 41 where the metal strips 4 and 5 can then be joined together, for example by stapling, clinching, welding, gluing, or the like. The strip connection is thus created near the leading end of one of the strips, the upper strip 5 in this embodiment. The drive 42 can then be opened, and the lower metal strip 4 is then pulled with the upper metal strip 5 secured thereto through the apparatus, so that the plastic web 6 also reaches the second laminater 34 and the continuous manufacturing process can begin.

By virtue of the heaters provided in the described lamination line L, the manufacturing process can be varied and particularly adapted to the characteristics of the plastic web being used, particularly to its melting point. A plastic web or plastic film is thus preferably used that has a melting point of greater than 200° C., for example about 220° C., that can have a recrystallization temperature of about 190° C. to 200° C.

The heater 29 raises a temperature of the first metal strip 4 to above the melting point of the plastic web, for example to a temperature greater than 200° C., for example about 250° C. The plastic web 6 is also preheated in the heater 30, but to a temperature substantially below the melting point of the plastic web, for example to a temperature from 25° C. to 100° C. The composite of first metal strip 4 and plastic web 6 is subsequently heated together in the furnace 32, particularly to a temperature near the melting point of the plastic web, for example to a temperature between 200° C. and 250° C., for example about 220° C. to 230° C.

The second metal strip 5 is also heated in the heater 33 to a temperature above the melting point of the plastic web, for example to a temperature above 200° C., for example about 250° C.

In the second laminater 34, the metal strips 4 and 5 and the plastic web 6 thus have a temperature near the melting point of the plastic web. Subsequently, there is additional heating in the heater 35, particularly preferably to temperatures above the melting point, for example temperatures greater than 220° C., for example about 250° C. At this temperature, the strips are joined together with interposition of the liquefied plastic web in the press 36. Additional adjustment of the temperature is effected in the heater 37, and further joining occurs in the press 38 at temperatures below the melting point of the plastic web. Cooling and consolidation is then performed in steps in the above-mentioned coolers.

It will readily be understood that the described temperature control is cited merely for the sake of example and is adapted according to the characteristics of the plastic web used.

1. A method of making composite webs or composite sheets consisting of at least one first outer layer of metal, one second outer layer of metal, and at least one core layer of plastic that is between the outer layers and integrally joined therewith, the method comprising the steps of:
supplying a first metal strip for the first outer layer, a second metal strip for the second outer layer, and at least one plastic web for the core layer,
continuously coating each of the first and the second metal strips with an adhesion promoter on a pretreatment line and and thereafter winding up each of the coated first and second metal strips,
unwinding and then bringing together the first and the second coated metal strips and the plastic web in a lamination line that is separate from the pretreatment line, and
thereafter joining the unwound coated strip together with the plastic web continuously under application of pressure and heat to form a composite web.

2. The method according to claim 1, wherein the pretreatment line is operated at a higher speed than the lamination line.

3. The method according to claim 1, further comprising the step of:
cleaning each the metal strips in the pretreatment line.

4. The method according to claim 1, further comprising the step of:
straightening the metal strips in the pretreatment line by stretch-bend straightening and/or lengthening.

5. The method according to claim 1, further comprising the step of:
heating or drying the metal strips in the pretreatment line after coating with the adhesion promoter.

6. An apparatus for making composite strip or sheets that consist of at least one first outer layer of metal, one second outer layer of metal, and one core layer of plastic that is between the outer layers and integrally joined therewith, the apparatus comprising:
a pretreatment line for unwinding, then coating each of the first and second metal strips and for thereafter winding up each of the first and second metal strips; and
a lamination line separate from the pretreatment line and having a first unwinder for unwinding the coated first metal strip, a second unwinder for unwinding the coated second metal strip, a third unwinder for the plastic web, and a joiner that brings the unwound and coated first and second metal strips together with interposition of the unwound plastic web.

7. The apparatus according to claim 6, wherein the joiner has:
a first laminator with which the plastic web can be brought together with the first metal strip, and
a second laminator with which the second metal strip can be brought together with the plastic web that is on the first metal strip.

8. The apparatus according to claim 6, wherein the joiner has:
a preheater for the first metal strip,
a preheater for the second metal strip,
a preheater for the plastic web, and/or
a post-heater for the first metal strip and the plastic web thereon.

9. The apparatus according to claim 6, further comprising:
a heater and/or press downstream of the joiner.

10. The apparatus according to claim 6, wherein the coater is a roller coater with at least one application roller and one support roller.

11. The apparatus according to claim 6, wherein the pretreatment line has at least one cleaner for the strips.

12. The apparatus according to claim 6, wherein the pretreatment line has a stretch-bend straightener.

13. The apparatus according to claim 6, further comprising:
a skin-pass mill for temper-rolling in the pretreatment line.

14. The apparatus according to claim 6, wherein the pretreatment line is operated at a workpiece throughput speed that is at least twice that of the lamination line.
